(19) United States
(12) Patent Application Publication
(10) Pub. No.: US 2012/0208557 A1
(43) Pub. Date: Aug. 16, 2012

(54) Location Reliability Determination

(76) Inventor: Robert A. Carter, Luxembourg (LU)

(21) Appl. No.: 13/502,780

(22) PCT Filed: Oct. 19, 2010
(86) PCT No.: PCT/EP2010/065735

§ 371 Date: Apr. 19, 2012

(30) Foreign Application Priority Data
Oct. 19, 2009 (EP) PCT/EP2009/063694
Apr. 16, 2010 (LU) 91679

(51) Int. Cl. H04W 4/00

(52) U.S. Cl. 455/456.1

(57) ABSTRACT

A system, method and apparatus is provided that allows the determination of the reliability of a location determined by a mobile device in response to Navigation System signals. The mobile device sends positioning information derived from the Navigation System signals to a server, the server comparing the positioning information to reference information received from base stations in order to determine its reliability.

This invention relates to systems, methods and apparatus for use with Navigation Systems. In particular, the invention relates to ways to determine the reliability of signals received from a Navigation System and hence the reliability of a determined location based on the signals.

In general terms security systems usually use authentication processes to enable a user to access a domain (that may be physical or virtual) that applies a policy or policies to restricting access to such domain. Only after successful authentication the user is granted certain privileges enabling the user to execute certain tasks within the domain he has been admitted to. While in the past these domains were normally physical areas or territories like factory sites or private properties, these domains are more and more extending to include virtual domains such as websites, internet shops, remote data storage facilities but also mail services or indeed anything that belongs to the “cloud” and that needs to have an access control mechanism governing the access.

Authentication is the process of checking and validating the identity of a user (or an object) requesting access to a restricted area whereby the check and validation can be performed by using so-called authentication factors. Traditionally these factors are associated to what the user seeking access knows (like a code), has (such as a card with token) and/or represents. The latter may comprise biometric characteristics such as a fingerprint, hand geometry, retinal, voice or DNA information or the like. Granting rights or privileges to those who have been positively authenticated is usually referred to as “authorisation” a procedure that is often seen as an integrated part of authentication (or vice versa). In this disclosure authorisation is regarded as an independent instance receiving authentication information unless otherwise stated.

Moreover, recently the introduction of a further authentication factor has been suggested based upon the exact location where a person (or object) is located at one given moment in time. It is clear that one single person cannot be at different locations at one single moment in time and therefore the use of location based authentication would make strong authentication procedures even better. The location of the person (or object) may be determined using a Navigation System, such as a Global Navigation Satellite Systems (GNSS). The accuracy of timing systems comprised in precise clocks used by GNSS such as GPS offers nanosecond precision thus making it possible to timestamp an event, a transaction or equivalent in a simple and transparent way in combination with the associated location thereof. A description of such a system can be found in international patent no. PCT/EP2009/063694, the contents of which are incorporated herein by reference.

However, the location provided by a person may be faked, and the security system has no way of assessing the reliability or integrity of the location provided by the person.

Furthermore, when Navigation Systems are used in safety-critical applications, such as aircraft navigation or the tracking of hazardous goods, current systems for checking the reliability of Navigation System signals and locations derived therefrom are bulky and expensive, requiring significant processing capacity and imposing power requirements. When the system is to be incorporated in a battery powered Mobile Device, this causes problems with implementation. Furthermore, integrity checking systems such as Receiver Autonomous Integrity Monitoring (RAIM)—that currently cannot be incorporated in truly mobile and portable devices anyway—may be unable to determine when interference is jamming signals, or when the signals received by the system are fake signals generated maliciously or accidentally.

### SUMMARY OF INVENTION

According to a first aspect of the invention, there is provided a verification method, the steps of the method comprising: receiving positioning information from a mobile device, the positioning information being derived from Navigation System signals received by the mobile device; receiving reference information from a base station, the reference information being derived from Navigation System signals received by the base station; and comparing the positioning information to the reference information such that the reliability of the positioning information can be verified.

Using such a method provides a way to determine the reliability of Navigation System signals without having to burden the mobile device with additional systems or without having access to complementary signals providing integrity or reliability information. Furthermore, by comparing signals received by the mobile device with those received by a base station, it may be possible to identify when spoofing, jamming or other intentional or unintentional interference is affecting the Navigation System signals received by the mobile device, whether malicious or otherwise, which the mobile device would not be able to detect itself.

The Navigation System signals may be received from Global Navigation Satellite Systems (GNSS) such as GPS or forthcoming systems such as Galileo or GLONASS, or other Navigation systems dependent on ranging such as Regional Navigation Satellite Systems and ground based systems such as Local Area Augmentation Systems and GSM or WLAN location finding systems or the like. It may be possible for the mobile device to receive signals from a plurality of Navigation Systems at once, in which case the positioning information may be derived from the signals received from one or more of the Navigation Systems.

Advantageously, the positioning information and reference information comprise at least a portion of a Navigation System signal; and the comparing step comprises comparing at least a part of the portion of the Navigation System signal in the positioning information with at least a part of the portion of the Navigation System signal in the reference information to determine if there is a difference within the Navigation System signal as received by the mobile device and as received by the base station.

Accordingly, the contents of the Navigation System signals can be compared to check for anomalies such as interference, false signals and the like.

Optionally, the positioning information and reference information comprise the order in which Navigation System signals were received by the mobile device and base station respectively; and the comparing step comprises comparing the order in which Navigation System signals were received by the mobile device and base station.

Accordingly, the order in which the signals are received by the mobile device can be compared to the order of receipt of the signals as recorded by the base station, which offers a simple plausibility check for the signals. The positioning information may be reduced in size, hence reducing bandwidth requirements, and the processing of the information is relatively straightforward reducing processor time required. In this case, it is preferable that the base station is relatively near the mobile device.

Optionally, the positioning information and reference information are related to the time of flight of at least one Navigation System signal; and the comparing step comprises comparing the times of flight of equivalent Navigation Signals. Equivalent Navigation signals in this case refer to signals originating from the same source, for example the same satellite in a satellite based Navigation System such as GPS. In this case, the time of flight may be communicated by indicating the pseudo ranges determined by the mobile device and base station.

Accordingly, the distance between the source of the Navigation System signal and the mobile device can be compared to the distance between the source of the Navigation System signal and the base station, offering an alternative simple plausibility check.

Advantageously, the method may further comprise: determining the expected positioning information for a mobile device located at a given location based on the reference information; wherein the comparing step comprises comparing the positioning information to the expected positioning information.

Accordingly, the positioning information for a particular location can be determined in advance and compared to the positioning information received from the mobile device. This may be advantageous in the case when the method is used to verify the reliability of a location used in a location based authentication system. For example, the positioning information for an ATM may be determined and, when a request to authenticate a transaction at that ATM is received, the positioning information from the mobile device may be compared to the determined positioning information.

Advantageously, the method may further comprise: storing at least a portion of the positioning information received from the mobile device; wherein the comparing step comprises comparing the positioning information to at least part of the portion of the stored positioning information to determine if there is a discontinuity in the positioning information over time.

Accordingly, the positioning information produced by the mobile device can be monitored over time for discontinuities, such as a sudden change in the satellites visible to the mobile device, or a sudden change in their orientation, distance or the like, or other inconsistencies or abnormalities in the positioning information.

Advantageously, the method may further comprise: determining the location of the mobile device based on the received positioning information; receiving location information from the mobile device representing the location of the mobile device as determined by the mobile device; and comparing the determined location with the location information received from the mobile device.

Accordingly, the location determined by the mobile device can be checked for accuracy, and possibly corrected in response to errors in the location determination. Such correction may take advantage of superior processing power by using a processor in a server that is not subject to battery requirements, and may further take advantage of additional information from other base stations not in communication with the mobile device.

Preferably, the reference information further comprises Navigation System correction information; and determining the location of the mobile device includes using the correction information.

Accordingly, the determination of the mobile device's location may be enhanced by access to the correction information which the mobile device may not normally be able to access. For example, Satellite or Ground Based Augmentation System signals may be used. Alternatively, the base station may be able to determine correction factors by comparing its known location to its determined location based on Navigation System signals.

Alternatively, the method may further comprise: sending a signal to the mobile device indicating which portion of the Navigation System signals received by the device are to be incorporated into the positioning information.

Accordingly, the mobile device may be able to transmit only a portion of the information required to determine the location of the mobile device, improving privacy and reducing bandwidth congestion.

Advantageously, there may be provided a method for use in authenticating a transaction comprising: receiving a request from a terminal to authenticate a transaction; receiving information from the terminal identifying a token that is being used to initiate the transaction; identifying a mobile device that is associated with the token; determining the location of the mobile device; verifying the determined location of the mobile device by verifying the reliability of the position information derived from the Navigation System signals received by the mobile device according to the above methods; comparing the location of the mobile device to the location of the transaction; and authenticating the transaction if the location of the mobile device is within a predetermined area relative to the location of the transaction and the location of the mobile device has been verified.

Accordingly, the method for authenticating transactions based on the location of the mobile device is improved by determining the reliability of the location of the mobile device so that a transaction request can be rejected if the location of the mobile device is unreliable.

According to a second aspect of the invention, there is provided a system for determining the reliability of Navigation System signals received by a mobile device; the system comprising: a mobile device having a Navigation System receiver and adapted to produce positioning information derived from Navigation System signals; a base station having a Navigation System receiver and adapted to produce reference information derived from Navigation System signals; a server having a processor; a first communication link between the server and mobile device for transmitting positioning information from the mobile device to the server; and a second communication link between the server and the base station for transmitting reference information to the server; wherein said processor is adapted to compare the positioning information to the reference information such that the reliability of the positioning information can be verified.

Accordingly, the system may use information from the base station and mobile device to carry out verification. It may be preferable that the first and second communication links are links within the same telecommunication system, such as a GSM mobile phone system.

Preferably, the positioning information and reference information comprise at least a portion of a Navigation System signal; and the processor is adapted to compare at least a part of the portion of the Navigation System signal in the positioning information and at least a part of the portion of the Navigation System signal in the reference information to determine if there is a difference within the Navigation System signal as received by the mobile device and as received by the base station.

Alternatively, the positioning information and reference information comprise the order in which Navigation System signals were received by the mobile device and base station respectively; and the processor is adapted to compare the order in which Navigation System signals were received by the mobile device and base station.

Alternatively, the positioning information and reference information are related to the time of flight of at least one Navigation System signal; and the processor is adapted to compare the times of flight of equivalent Navigation Signals.

Advantageously, the processor may be adapted to determine the expected positioning information for a mobile device located at a given location based on the reference information; and the processor may further be adapted to compare the positioning information to the expected positioning information.

Optionally, the server may further comprise memory coupled to the processor for storing at least a portion of the positioning information received from the mobile device; wherein the processor is adapted to compare the positioning information to at least part of the portion of the stored positioning information to determine if there is a discontinuity in the positioning information over time.

Advantageously, the processor may be adapted to determine the location of the mobile device based on the received positioning information; and the processor may further be adapted to compare the determined location of the mobile device with the location of the mobile device as determined by the mobile device.

Optionally, the base station may further comprise a Navigation System correction system receiver and be adapted to produce correction information derived from Navigation System correction system signals; and the processor may be further adapted to determine the location of the mobile device using the correction information.

Preferably, the server is adapted to send a signal to the mobile device indicating which portion of the Navigation System signals received by the device are to be incorporated into the positioning information.

Advantageously, an apparatus for use in multi-factor transaction authentication may comprise a terminal, the terminal comprising: token reading means, the apparatus further comprising: identifying means for identifying a mobile device associated with said token; determining means for determining the location of said mobile device; a system for validating the reliability of Navigation System signals received by the mobile device by verifying the reliability of the positioning information derived from the Navigation System signals received by the mobile device, as described above; and comparing means for comparing the determined location of said mobile device with the location of a transaction. The elements of the apparatus may be co-located or part of the same system or physically separated with means of communication between them. Such communications may be a mobile telephone network or the like or fixed communications where appropriate, for example between a central verification facility and a fixed terminal.

Accordingly, the apparatus may augment a first level of authentication, using a token which may be for example a smart card and an authentication key which may be a PIN code, signature or the like, with a second level of authentication based on location, this second level of authentication being further improved by determining the reliability of the determined location.

According to a third aspect of the invention, there is provided a server for determining the reliability of Navigation System signals received by a mobile device; the server comprising: mobile device communication means for receiving positioning information derived from Navigation System signals received by the mobile device; base station communication means for receiving reference information derived from Navigation System signals received by a base station; a processor; wherein said processor is adapted to compare the positioning information to the reference information such that the reliability of the positioning information can be verified.

The base station communication means and mobile device communication means may be implemented using the same system, for example a mobile telephone network or the like.

Advantageously, the positioning information and reference information comprise at least a portion of a Navigation System signal; and the processor is adapted to compare at least a part of the portion of the Navigation System signal in the positioning information and at least a part of the portion of the Navigation System signal in the reference information to determine if there is a difference within the Navigation System signal as received by the mobile device and as received by the base station.

Optionally, the positioning information and reference information comprise the order in which Navigation System signals were received by the mobile device and base station respectively; and the processor is adapted to compare the order in which Navigation System signals were received by the mobile device and base station.

Optionally, the positioning information and reference information are related to the time of flight of at least one Navigation System signal; and the processor is adapted to compare the times of flight of equivalent Navigation Signals.

Advantageously, the processor is adapted to determine the expected positioning information for a mobile device located at a given location based on the reference information; and the processor is further adapted to compare the positioning information to the expected positioning information.

Optionally, the server may further comprise memory coupled to the processor for storing at least a portion of the positioning information received from the mobile device; wherein the processor is adapted to compare the positioning information to at least part of the portion of the stored positioning information to determine if there is a discontinuity in the positioning information over time.

Preferably, the processor is adapted to determine the location of the mobile device based on the received positioning information; and the processor is further adapted to compare the determined location of the mobile device with the location of the mobile device as determined by the mobile device.

Optionally, the base station communication means is adapted to receive correction information derived from Navigation System correction system signals received by the base station; and the processor is further adapted to determine the location of the mobile device using the correction information.

Preferably, the server is adapted to send a signal to the mobile device indicating which portion of the Navigation System signals received by the device are to be incorporated into the positioning information.

The verification in the above described aspects of the invention may be part of an authentication process which is used in a security system possibly as a complement to an authorisation process. Identification information identifying the mobile device is preferably received in the form of a unique identifier code which may contain information derived from Navigation System signals and/or alternatively information derived from the mobile device hardware. Authentication may then be carried out based on matching the unique code with the identity of the mobile device.

Advantageously, authentication information may be offered—possibly on request of an external independent process and comprising information indicating that a transaction can be processed—to an authorisation instance for use in establishing independently the rights and/or privileges that will be allotted by such an instance to the (legitimate owner of) the mobile device.

Location information received from the mobile device may additionally contain further information derived from the mobile operator or similar networks or other information sources available from incorporated or attached instruments to the mobile device such as compasses, gyroscopes etc.

The methods described above may be implemented using a computer program, said computer program being recorded on or embodied in a computer readable medium such as an optical or magnetic disk; solid state storage; a signal or the like.

The invention described herein may be beneficial for various categories of products and/or services thanks to its universality that can be deployed in many different scenarios examples of which are:

1) Infrastructure services, providing data on the functionality of the Navigation System to service providers who base their business model on providing road transportation services (such as road toll), location based services, time synchronisation services or similar. Reference is also made to using GNSS data for emergency services and its importance for national security.

2) General authentication-as-a-service applications and industry specific solutions, particularly as a complement to authorisation systems which may be an independent instance in the area of financial services, e-commerce, access control, tracking services, logistics, leisure etc.

3) Appliances and devices for the general public as well as special purpose appliances or devices.

The invention will now be described by way of example and with reference to the Figures in which:

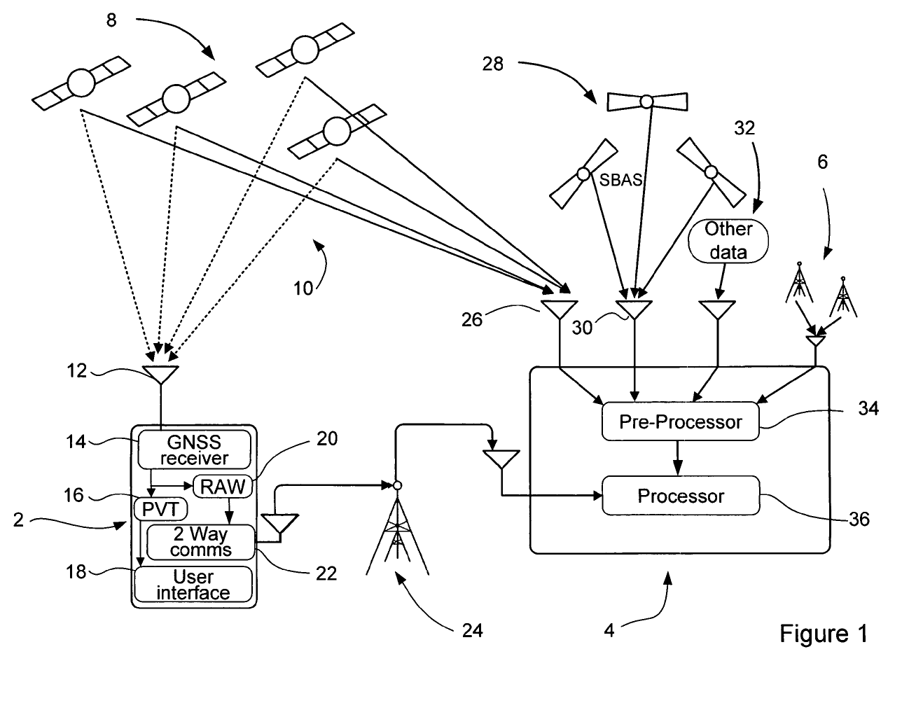

FIG. 1 is a schematic depiction of a mobile device, server and associated signals being sent and received between them and a GNSS;

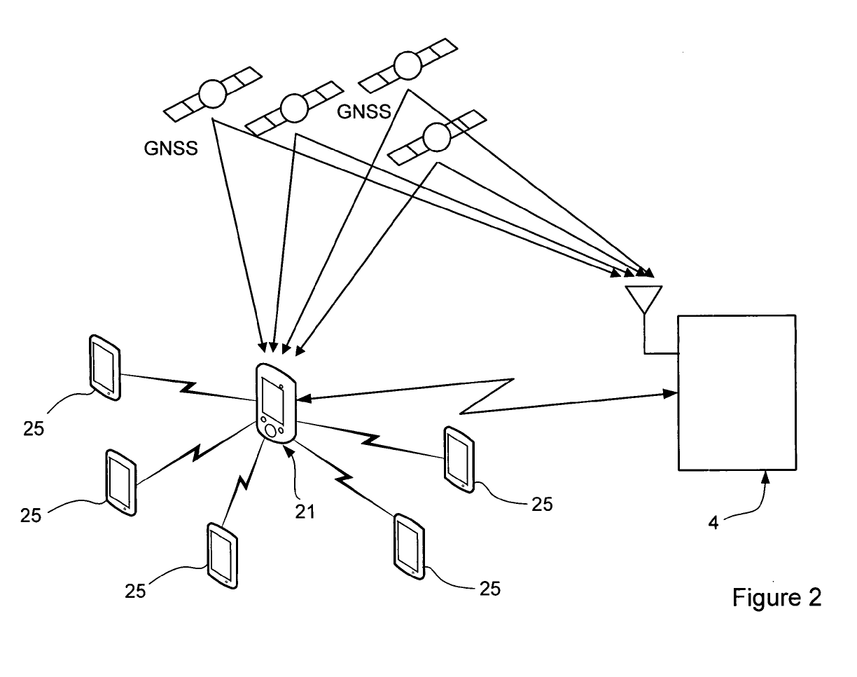

FIG. 2 shows a modified version of the system shown in FIG. 1 with a plurality of dependant devices; and

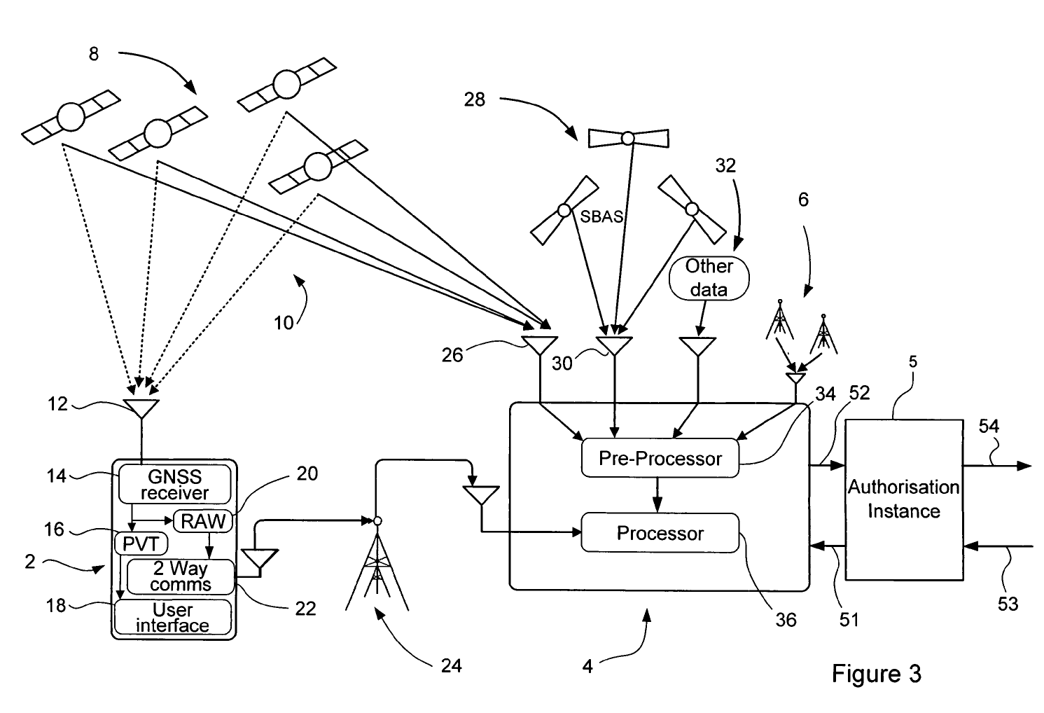

FIG. 3 is a further schematic showing additional authentication functionality.

This disclosure uses the term Navigation System in a generic way to refer to spatial and terrestrial systems offering similar functionality and benefits to GNSS such as Regional Navigation Satellite Systems (RNNS) or ground based Local Area Augmentation Systems (LAAS). Although these systems offer only a limited geographical coverage as opposed to the Global NSS positioning systems like GNSS, RNSS and LAAS are designed to work in a seamlessly operating overall system. Therefore while the wording Navigation Systems is used herein it also refers to other space or ground based navigation systems such as comprising RNSS and LAAS.

In particular, terrestrial based radio beacon systems usually do not offer the same quality of location data compared to dedicated GNSS or RNSS and are also not offering the same level of location finding possibilities. It is however possible to use signal data triangulation methods to enable an approximate location or when used in short distance measurements to arrive at relatively good location finding performance. Accordingly, the term Navigation System is meant to include terrestrial radio beacon systems such as GSM, WLAN, WIMAX, Zigbee etc.

In this disclosure, the reliability of Navigation System signals is used to indicate how trustworthy the signals received from such a System are, and hence whether a location determined using the signals can be relied on. The reliability of such signals may be affected by degradation of the signals caused by range or interference, as well as malfunction of an aspect of the Navigation System, e.g. a satellite failure in GNSS. Furthermore, the reliability of the signals may be affected by deliberate interference, jamming or “spoofing” of spurious signals which could lead to an inaccurate location determination. The term reliability is used to further incorporate such concepts as the integrity and security of the signals.

The term “mobile device” is used herein to refer to a device which detects Navigation System signals, the reliability of which is to be ascertained. This may include mobile or stationary electronic devices such as cellular phones, personal digital assistants (PDA), Navigation devices, desktop computers, set-top boxes, gaming devices that are linked to a gaming console through wire or indeed household appliances, industrial terminal equipment and purpose built devices fixed to vehicles etc. for as long they are Navigation System signal enabled and have (access to) communication means to communicate with a remote central facility or server.

Navigation System signals may be contained in a broadcast message with a fixed structure and are usually captured by a receiver that may be incorporated in a device comprising an antenna with associated RF stage receiving the signals from the antenna, tuning, amplifying and mixing the signal for subsequent pass-on to the signal processor via the IF filter. Depending on the type of the processor built into the receiver a multitude of different satellite signals can be correlated and decoded. The signal processor possesses its own real time clock and processes the source data (such as the signal transit time) and hands over relevant data to the controller that uses such data to compute PVT (=Position, Velocity & Time). The controller may also control the signal processor by “programming” it such a way that it will perform various instructions provided by the controller. Moreover the receiver usually comprises apart from a power providing device a display as well as an input device.

In this embodiment, the authentication process checks and assesses the reliability and integrity so that the authentication tests result in assured information comparable to a certificate ensuring that the capturing device was, at a specific moment in time, at a verifiable location. Such assured information or certificate can then be used by an authorisation instance to grant rights and/or privileges.

With reference to FIG. 1, an embodiment of the invention is illustrated. A mobile device 2 receives signals 10 from a Navigation System, in this case a GNSS, 8 via an antenna 12. These signals 10 are converted to a digital signal by receiver 14, although the skilled man will realise that it may be possible to use analogue or other signals without digital conversion. These signals may then be processed by Position and Velocity processor 16 and the results relayed to a user via a display 18. However, in order that the reliability of the signals 10 may be determined, they are also passed to positioning information processor 20 and the output of positioning information processor 20 is then transmitted by the mobile device using transmitter 22 via the cellular network 24 to server 4.

The positioning information produced by positioning information processor 20 may take a number of different forms. For example, it may include the entirety of one or more Navigation System signals received by the mobile device. Alternatively, it may include other information such as time of receipt of a GNSS signal from a particular satellite according to the mobile device's internal clock synchronised or not with the clock(s) operated by server 4. Alternatively, the positioning information may comprise only sections of a Navigation System Signal. For example, in the case of the GPS signals, the almanac and other redundant data may be omitted. The positioning information could alternatively indicate other information about the Navigation System signals, such as the order of arrival of Navigation System Signals from particular satellites, or relative arrival times of Navigation System Signals received from selected GNS devices, the estimated or calculated time of flight of the signal from its origin or the like. Of course, the positioning information may be encrypted. In this document, positioning and positioning information is not intended to be limited to location information or establishment of location. Positioning information may or may not comprise non-location data such as directional or overlay information provided by Inertial Measurement or Augmented Reality systems or encrypted or otherwise encoded location data or subsets of that.

The server 4 may also receive Navigation System signals 10 via its own antenna 26. It may further receive Navigation System signals from one or more base stations 6, which may be cellular telephone masts or other devices equipped to receive Navigation signals, located remotely to the server and preferably in various locations within or around the region in which it may be desirable to determine the reliability of Navigation System signals received by the Mobile Device 2. Accordingly, the server has access to the positioning information produced by positioning information processor 20 in the mobile device, as well as reference information produced by the server or base stations in response to Navigation System signals received by the base stations or server.

In the case that server 4 has its own antenna 26 for receiving Navigation Signals, and then the server could also be considered to be acting as a base station 6. The base stations 6 may be simple relay devices that forward the Navigation System signals 10 they receive via e.g. the wired telephone network. Alternatively, the base stations may carry out some processing of the signals they receive before sending the reference information to the server 4.

The server 4 has a pre-processor 34 that may collect reference information from the base stations 6 and antenna 26. It may further collect information from Navigation System correction systems, such as SBAS 28, or the like, via a further antenna 30. The pre-processor 34 may also have access to additional location-finding systems 32 or the like, for example a GSM range-finding system that operates in cooperation with the mobile device 2. These various pieces of additional information may also be collected by the base stations, and the server could potentially rely on the base stations without having its own antennas and the like to collect the information. Furthermore, some of the antennas used to collect the various sources of information could potentially be used for more than one system at the same time.

The pre-processor 34 then passes the information to processor 36, which carries out the comparison between the positioning and reference information, and any other processing that is to be done such as calculation of location and the like.

The server 4 may be able to compare the positioning information and reference information in one or more of a number of different ways. For example, in the case that the positioning information comprises all or part of an individual Navigation System signal, the contents of the signal as received by the mobile device 2 may be compared to the signal as received by base stations 6 to check for discrepancies. Such discrepancies may indicate the presence of unintentional interference, or that the positioning information has been forged.

Alternatively, the order of arrival or time of flight of Navigation System Signals from a selected satellite or other source may be compared between the mobile device and a base station. If the base station and mobile device are close to each other in location then they will receive Navigation System Signals from selected sources in the same order, therefore a difference in the order of receipt of the Navigation System Signals indicates a potential problem with the reliability of the signals. Similarly, the time of flight, or pseudorange, for a signal from the same satellite should be similar for the mobile device and base station where they are close to each other. Accordingly, a significant difference can indicate a particular problem with the signals. In such a case, it is preferable that the base station is located near the mobile device. This may be determined, for example, by the base station being based on a cellular telephone tower and accordingly the server considering reference information received from the base station that is on the cellular telephone tower with which the mobile device is communicating.

Furthermore, the server may be able to determine whether the location as determined by the mobile device is reliable, by comparing it to the location determined by the server based on the positioning information.

The processing of the positioning information is performed in a central facility remote from the mobile device and possibly remote from the base stations on the basis of information that is provided by the mobile device at the one hand and by independent reception at the other. This may enable improved and more accurate location establishment by the server for the location of the mobile device at the same time as the integrity of the information is checked.

The server may be equipped with receivers capable to capture and process the GPS/GNSS messages as well as SBAS, GBAS and any other relevant location data. Moreover the base stations may enable the server to receive and use data from satellites which the server is unable to receive signals from, for instance those satellites orbiting at the opposite hemisphere and only “visible” from base stations located there. The base stations may further include receivers for augmentation systems such as SBAS, GBAS and the like.

Having access to these two different sets of data, one set coming from the mobile device which may be with incomplete data (in the case that some, such as the GNSS almanac data is excluded) and another set of data provided by various trusted sources makes it possible to re-engineer the quasi totality of the original streams of satellite signal data as they were received by the mobile device so that an accurate location of the device can be computed by the processing facility or location and/or positioning information provided by a mobile device can be verified.

However as previously mentioned the now available data would also provide the possibility to compute error corrections, not only those caused by atmospheric conditions, but also for areas where local conditions impact the quality to properly calculate the location of the mobile device. By comparing location computation results using different sets of data (like including or excluding augmentation data from SBAS or GBAS) differences in results will appear which represent error correction factors which may be taken into account to improve the accuracy of the location even more.

Similarly it is now possible to use navigation system signal comparison, it is recalled that one set of navigation system signals comes from the mobile device and the other is obtained independently thereof, enabling the direct assessment of the GNSS only data with GNSS plus augmentation data. The one-on-one and one-by-one comparison of signals coming from the same source (e.g. the same GPS satellite) but received at different places enables to establish the quality of the captured data from one source with those originating from a group of different independent sources. So-called performance levels horizontally and vertically measured (also referred as HPL and VPL or Horizontal Integrity Limit—HIL or Vertically as VIL) will be established thereby creating a Quality of Service (QoS) providing an objective tool for service providers who currently lack such instrument to measure their services provided to their customers.

Apart from the signal data comprised in the positioning information further data provided by the mobile device may be available. For example, supporting information such as time zone may be provided aiding in reducing the possible locations from where the mobile device is located. For example, a code may be included in the supporting information to pre-identify a large geographical zone (provenance zone) such as a country and the cellular provider through which the signal data is transmitted. This zone can be traced back to various satellite constellations which are visible at that specific zone and the satellites that cover at that moment in time the provenance zone.

As a consequence the processing facility will be capable to derive from the supporting information which satellites are not covering the provenance zone at that given time so that any positioning information referring to non visible satellites in the provenance zone is already a strong indicator that the signal data may have been compromised at or before the capture of such data by the mobile device. Further verification with the help of independently received data at the processing facility or from other networked sources may give further proof of the authenticity of the signals so that a definite assessment is possible as to the integrity of those signals.

In the case of a discrepancy, further actions may be taken to understand such discrepancy by—as an example—relating such data with previous data received during the same session by comparing the previous location at a time T0 minus x and the data at the time T0. Such comparisons which may also be made together with other last known previous data will provide further evidence as to the reliability and integrity of the signal data that has been received from the mobile device.

Using the almanac data to compute in advance patterns of possible constellation will be a further help to distinguish between (potentially) fraudulent requests and genuine ones. Almanac data have, in addition to their inaccuracy regarding the position of the GNSS satellites, a limited useful life, but still provide sufficient information to predict with a high degree of accuracy which satellites will fly over a certain region at what approximate time.

This knowledge will be used to compute tables (in advance) representing possible satellite combinations that are theoretical visible from approximate locations within the provenance zone. These hashed tables are like rainbow tables which can be used to quickly look up whether positioning information provided are legitimate seen from the theoretical satellites availability perspective. Having such tables and by combining them with prior knowledge data will enable the processing facility to filter out certain requests in an early phase within the processing chain

An improvement in securing the system can be achieved by applying a variable algorithm to fragment the GNSS data streams thereby creating possible different positioning information in spite of being at the same location at a given moment. The choice of which algorithm should be used may be triggered by an outside signal which cannot be influenced by the user of the mobile device. The server to which the mobile device is attached using a wireless connection could provide the outside signal which may be in the form of a code that may be equivalent to a so-called One-Time Password (OTP) that includes time and location references.

The OTP would trigger the use of a certain algorithm in the mobile device to vary its method by providing the OTP as a fragmentation key so that the process of fragmentation of raw data would follow a pattern that would result in a different outcome even if the basis of raw data would be exactly identical. This key would be instrumental in defining the content of the positioning information.

Still it may be considered prudent to verify whether the data has not been tampered with before arrival at the remote facility. To this end the mobile device may use hashing methodologies to arrive at a so-called hash of the positioning information before sending it out to the central facility. At the same time the central facility will calculate a hash of the received positioning information using the same hashing technology as was used by the mobile device. The data integrity is established by comparing the hash provided by the mobile device to the facility with the one the latter calculated itself using the data received. After the positioning information has arrived at the remote facility it is processed, potentially taking into account the applicable OTP indicating which portions of the GNSS signals will be present, to derive the moment and time the signal data was captured by the mobile device thereby enabling the location and time of capture of such device.

As a further improvement it may be considered to use non-GNSS data to pre-locate the most likely region where the mobile device is currently located. Assuming that the mobile device is using the services of a cellular network it would be possible to send information on the local time used by the network the mobile device is booked into, the network identifier of the latter and the country code applicable for that network before transmitting the information.

In this context reference is made to the standardised classification and structure of the various cellular networks that are linked together into the global GSM network and the way the traffic is passed on from one cell to another as well as those cases when users leaves their home network and access a host network with the associated procedures to hand-over the communication. Some information available in cellular networks that can be used is mentioned hereunder.

### MCC=Mobile Country Code

### MNC=Mobile Network Code

### HMI=Home Network Identity (MCC+MCN)

### IMSI=MCC+MNC+MSIN (Mobile Station ID Number)

A further set of data that can be used to facilitate the process and will reduce processing time comes from electronic instruments that are already or may be built into the mobile device. As an example cellular phones are becoming more and more equipped with electronic instruments such as compass, accelerometers, gyroscopes, pedometers, providing information on the direction and/or speed of the direction. It is conceivable to use a very rough indication of the location of the mobile device which may not be accurately locatable using GNSS only data. By complementing such indication with direction and/or speed information it is possible to arrive at a much better and more accurate location computation compared to a calculation using GNSS only.

This result can be improved by using an object like a building, sculpture known to Point-Of-Interest (POI) information systems as a Point-Of-Reference (POR). By pointing towards such POR that may be visible under a certain angle by the user a further measurement is provided thereby arriving at a rather precise location calculation certainly compared with the method using GNSS only data. Moreover, when making use of cameras, still or video, the environment surrounding the user may be captured and can be matched after relay to the central facility against known locations that are held in databases. While this method of supplying additional data to facilitate the speedy computation is time efficient, it may be against one of the objectives of the security system—concealing the location of the user—to provide picture or video material that can easily be recognised especially when the user is at a well known touristic environment. Therefore it would be optionally possible to transmit the additional data as mentioned above in a way that would not be easily understood by outsiders to the security system. This can be in a scrambled format complemented with encryption. Having knowledge of these data alone would not be sufficient to compromise the security offered by the system, which means that similar security measures are not required to conceal the signal data.

As explained before, the security system described herein is using non-traditional methods to calculate the position of the user associated to the mobile device. In order to arrive at the high levels of location accuracy and in order to warrant the signal and system integrity then the server requires access to different streams of Navigation System signals provided by different sources, one source being the mobile device and another being the server or base station. A mobile device does not have the resources to gather such information due to inter alia memory, processor and bandwidth constraints and therefore the processing of such location data is performed at a dedicated remote processing facility that is equipped with the necessary hard- and software enabling the required processing.

The facility has in contrast to the mobile device also access to other location sources such as augmentation systems like Satellite Based Augmentation Systems, SBAS, or Ground Based Augmentation Systems or GBAS data (both systems improving the GNSS data), is capable to extract and apply correction factors improving the quality of the location establishment and is therefore capable to compare the signal data coming from various sources to derive the integrity of the signal data that was received by the mobile device.

The proper comparison of signal data coming from the mobile device and those that were independently received by the processing facility will not be possible when only end results i.e. the processed location—as an example—grid coordinates are communicated by the mobile device to the central processing facility. In fact the best possible comparisons will be made when so-called unprocessed signal data such as the raw messages used in GNSS are relayed by the mobile device to the processing facility for comparison purposes. Also part processed signal data such as the (pseudo)ranges can be used, however this “second generation” data will enable lower quality results and therefore the security system will preferably use unprocessed signal data as is described hereunder.

It is known that GNSS technology still have some technical drawbacks inhibiting the accurate localisation when the receiver is used in certain areas (e.g. with high rise buildings, indoors or dense forests), during certain periods of bad weather, during solar eclipses to name a few. Therefore it is desirable to complement the GNSS location methods with further location sources that off-set these GNSS weaknesses and will as a consequence improve the security system.

In order to correct the above problems linked to unfavourable Loss of Sight (LOS) conditions or factors that disturb the proper signal reception GNSS can be supported by complementing the GNSS data with data from augmentation systems as previously mentioned. These systems may help to eliminate in-space atmospheric conditions in the ionosphere or troposphere and certain geostationary satellite systems equipped with special purpose equipment can assist GNSS by functioning as references stations or beacons thereby making it possible to reduce the errors due to above conditions.

Such satellite systems are usually referred to as SBAS; the US WAAS and the European EGNOS or the Japanese MSAS are operational examples of such SBAS systems. A further advantage that is associated with SBAS is that they are capable of providing complementary data to enable the filtering out of signal errors and disturbances effects resulting in the improved accuracy of establishing the location of the user (or to be more correct the users' receiver).

SBAS makes use of various networked base stations located within the area the SBAS is operating. These stations receive the GNSS signals and are used to determine any difference between the surveyed location and the newly calculated location of the station. After sending such data to a control centre the corrected data are established applicable to each reference station and transmitted to satellite uplink stations for distribution by the different geostationary satellites carrying a SBAS payload. In turn these geo-satellites relay the correction data back to earth and can be used by GNSS receivers with SBAS capabilities inter alia meaning that such receivers should be RTCA standard compliant.

Moreover terrestrial referencing systems may offer similar features as SBAS systems as is proven by so-called GBAS sometimes also referred to as Local Area Augmentation Systems (LAAS). In addition to GBAS also Ground Regional Augmentation Systems (GRAS) exist, both using terrestrial radio signals and are composed of one or more accurately surveyed ground stations. Most GBAS use the RTCM SC-104 standard to transmit the correction data and therefore the GNSS receiver must be equipped with special decoders in order to receive and process such data.

Furthermore, the base stations may themselves be used in order to provide augmentation data. For example, a base station may have a known location and therefore it may be possible to derive correction factors for the Navigation System based on the discrepancy between its known location and the location indicated by the Navigation System.

It is recalled that the sources of the message broadcast are part of a GNSS that globally covers the earth. Any message that is received by the mobile device will also be received (directly or indirectly) by the central facility. This situation enables the integrity services of the central facility to compare individual parts of the signal data (or words as part of the overall message frame) of the unprocessed signal data of the message in such a way that conclusions can be drawn to what extent the “same” signals coming from different sources are identical and thus whether the signal data is reliable.

In such case one would be capable to compare part processed location data from the device such as pseudo range data with the independently captured data then much better possibilities are at the disposal of the processing facility to detect in quasi real-time if any attack has taken place to compromise the part location determination in this case using the said pseudo ranges as calculated by the mobile device.

The most optimum solution is to use signal data from the mobile device that has not been processed at all. In such a scenario, such signal data—when sent to the processing facility—can easily be compared to the independently obtained signal data that may be provided by different satellite based or ground based sources.

The integrity checking processes built into the security system will also benefit of better location accuracy as it inter alia compares a) one set of fragmented GNSS messages received by the mobile device and b) the complete referenced GNSS messages with SBAS/GBAS real-time corrections received by the processing facility. Any anomalies in the signal data will be detected as constellations of GNSS cannot be forged easily without having access to restricted technology in the area of precise constellation simulators. Furthermore it will be possible to compare the constellation information over time within the observation window a.k.a. authentication window so that sudden changes in constellation data provided by the mobile device will immediately be detected and be regarded as a possible attack on the security system.

This secure methodology de facto reversing the location establishment methodology is by far superior to existing techniques such as the various Differential-GPS flavours that inter alia use complementary ranging methodologies to improve GNSS measurements in the mobile device. Also the now often used A-GPS cannot compete with the system in terms of accuracy as it usually only helps the mobile device to arrive at a quicker TTFF (Time To First Fix) by deploying so-called aiding-data via a cellular communications network. Moreover ranging techniques based on GSM triangulation methodologies are not even coming close to traditional GNSS location establishment let alone to the secure system disclosed herein.

This unique solution does not require any new hardware equipment in the mobile device and in fact the existing receivers can be slimmed down as certain functionalities such as signal processing capabilities are not required anymore. It combines different state-of-the-art hybrid technologies and by adding the features of this invention to existing or future location services applications it is capable to produce secure next generation products and services. Moreover when combined with SBAS and GBAS data its performance would be such that features such as full indoor LBS capability will be within reach.

Moreover the ability of the security system to provide integrity checking features without having access to an integrity signal provided by the GNSS has far reaching consequences, not only at the level of improved levels of security and quality of service, it will also provide these benefits to low cost, extremely small GNSS capturing devices that do not need any location processing capacity on “board” of the mobile device. Much better operational autonomy will be achieved thanks to the low power consumption.

A further possible inhibiting factor, at least from the users' perspective, is also removed. Complications will be avoided as he would not be required to undergo potentially time consuming additional procedures or other processes involving a further user action inhibiting the user to enjoy the same level of convenience as current systems offer to him. Even worse these may be regarded as an intrusion into his privacy which may lead to the user reluctance to use such systems.

A possible use of the system described above is in the field of quality of service and integrity of data and signals. As previously explained the mobile device comprises basic GNSS capturing capabilities providing their information preferably to a central facility using a radio-based network. The facility is equipped with capturing and processing means to handle the data that is coming from a multitude of sources supported by a network of base stations. This network and these base stations may provide basic unprocessed data as well as processed data stemming from augmentation systems. Making available methods that provide the most accurate location, warrants the highest levels of integrity checking and offers best in breed security services at a low cost while deploying to the extent possible Commercial-Off-The-Shelf (COTS) appliances and components make this invention suitable for use by cost conscious operational entities looking for an integrated security solution or private individuals wanting to have an operational and easy to use infrastructure solution at their disposal.

In such scenario the security system can serve as a low cost alternative to the SBAS network by providing services similar to those of the EGNOS ground stations also referred to as RIMS (Ranging and Integrity Monitoring Stations) at a much lower cost and spanning a larger geographical area so that the information derived by the security system can be disseminated to countries who cannot afford a complete space based RIMS infrastructure and who would only be partially benefit of the ground based GBAS features without having the access to such network. Even more important the security system may provide relevant data for use by the RIMS network improving their service quality to users and can be regarded as an important contribution to the global security infrastructure.

As described before, in the most basic scenario the user requiring location information triggers the mobile device to capture the signal data coming from the GNSS containing the relevant constellation and time data and he sends the data in a maybe concealed format to a central facility that processes the data and derives an location of the receiving device that may be as accurate as up to 10 metres, as well as indicating the reliability of the location based on the reliability determinations explained above.

In case the mobile device would have had SBAS functionality (such as EGNOS in Europe or WAAS in the US) receiving capabilities built into the device this accuracy would come down to ⅔ metres and even better under ideal conditions.

In this embodiment the mobile device does not get any assistance data from external sources as the processing will always take place in the central facility thereby unburdening the mobile device processor with such additional processing tasks while at the same time improving the limited power budget keeping it available for more important and higher priority tasks.

The system is designed to use known objects known to the network as reference points for location referencing purposes. As they may be fixed and built at a very precise known location they can provide the system with actual location data that can be matched against referenced location data relative to such objects to precisely calculate any location measurement error that may occur due to meteorological, atmospheric or any other condition. The comparison performed on the basis of periodically new measurements will enable the creation of tables containing actual correction factors that may serve the system as well as other systems providing location services.

The grid of correction factors thus obtained provides factors will assist in improving the localisation method in such way that an ultra precise position can be calculated using low cost signal capturing equipment. In case such equipment would be installed on existing GSM cell towers no extra investments would be needed to build reference stations whereby the cellular communication network would also provide the service to send the captured GNSS signal to the central facility.

Moreover the cheap GNSS receiver that will need to be installed on the cell towers may in such circumstances be complemented with SBAS receivers as the limitations applicable to mobile receivers would not be applicable. In such hybrid SBAS annex GBAS scenario the selected and referenced cell towers would provide a further advantage. The reception equipment captures the broadcasts from the visible GNSS and SBAS/GBAS satellites from an ideal position where practically perfect LOS conditions are warranted.

Furthermore it will be possible to install special RIMS like receivers on specially selected cell towers that catch the INMARSAT/ARTEMIS raw EGNOS data and relay this data to a nearby RIMS facility for the usual EGNOS processing. This EGNOS raw data can then be obtained in remote areas without having a local complex and expensive infrastructure in place. Ranging and integrity and QoS services will be largely improved at a much lower cost.

Now the security system can provide advanced and accurate ranging correction methods which the system can make available to any user of navigation devices requiring high grade and reliable positioning or correction factors for their own positioning systems ranging from lorry drivers, postal services, financial and insurance services to even leisure seeking tourists. It allows using the benefits of EGNOS and also WAAS features to GNSS-only mobile as well as stationary users who have no SBAS capabilities built into their device. It improves the quality of the space based augmentation services in remote areas and uses existing reliable and commercially operational mobile networks' infrastructure to complement and enhance the infrastructure at a fraction of the investment cost.

Although the mobile device and server are depicted as using a cellular phone network to communicate, the skilled man will realise that any appropriate communications network may be used, including satellite communication and the wired telephone network. Furthermore, any appropriate communication network may be used for communications between the base stations and server.

Furthermore, the skilled man will realise that the server as described above may be able to determine the reliability of signals received by a base station by treating that base station as the mobile device and comparing the signals received to those of another base station.

Whilst in the embodiments above, information about position has been primarily described in relation to data obtained from in-space navigation systems such as GNSS as well as terrestrial systems such as pseudolite or repeater systems, other position and orientation information sources may also be used. For example, inertial measurement instruments (IMU) such as gyroscopes and pedometers, and digital compasses can provide data relating to position, orientation and movement. The information from such sources can be used to augment position data from GNSS sources, for example. This could be useful where GNSS signals are temporarily unavailable such as in tunnels or in buildings or simply to augment the GNSS data itself.

References to location determining means in this specification may incorporate Augmented Reality (AR) means for obtaining location information.

The system described above relates to authentication of a specific mobile device by a server. It will of course be clear to a skilled person that the server may provide authentication of multiple mobile devices either separately or concurrently. Similarly it is conceivable that a mobile device may be authenticated by more than one authentication server.

The above embodiment relates to a single mobile device communicating with a server. However, it may not be desirable or necessary to provide a device with location gathering or long range (e.g. GSM) communication if it can act as a dependant to another device. FIG. 2 shows an arrangement similar to the embodiments described above and shown in FIGS. 1 and 2 but with a number of additional dependant devices 25. The parent device 21 is similar and may be identical to mobile device 2 but in this embodiment additionally communicates with the dependant devices 25. The server 4 is essentially the same as in the preceding description.

The parent device 21 is connected to the server 4 over a network and receives GNSS broadcasts. The group or “network” of dependant devices 25 may only have short range communication means preventing them from communicating directly with a remote server 4 and may not have GNSS reception capability. However, they can communicate with the parent device 21 which is in close proximity.

The network of dependant devices 25 share positioning (and maybe other) information between network members with the assistance of the parent device 21. They may also communicate directly with each other to share information. Where the dependant devices 25 have no GNSS capability and no other means of determining their location, they can communicate with the parent device 21 to obtain location information from it (either directly or via another member of the network formed by the dependant devices 25 and the parent device 21).

Also, where the dependant devices 25 are not able to communicate with the server 4 directly, they may establish a connection to the server 4 via the parent device 21. Again that link to the parent device 21 may be direct or via one of the other members of the network.

In this way, each of the dependant devices 25 are able to provide similar authentication functions to the mobile devices 2 in the embodiment above.

Whilst the above embodiment anticipates the parent device and dependant devices 25 being mobile devices, the system may also be applied where some are not. For example, the parent device 21 may be fixed whilst the dependant devices 25 are mobile, allowing them to authenticate based on the location of the parent device as long as they are within range of the parent device. This might be used with a Bluetooth® or wireless network where the parent device is a modified access point. Furthermore, the parent device may actually be part of the server 4.

Similarly, the dependant device 21 may be fixed such as a desktop computer with the parent device being a mobile phone. This would allow a user to operate a computer to carry and authenticate and authorise a transaction by virtue of the presence and location of the phone but using the computer as a user interface.

One possible application of this embodiment is in a security scenario where security guards protect persons or objects against possible third party adversaries. The dependant devices 25 are connected to a parent device 21. The parent device 21 provides security relevant information to each of the “networked” guards carrying a dependant device 25, without necessarily requiring that all group members are connected directly to a central facility.

This system may also be applied (possibly with lesser security) to social networking systems, whereby the parent device 21 is connected directly to the server 4 and the dependant devices 25 are connected via local WiFi systems providing location information.

The present embodiment may be incorporated in part of an authorisation process such as a payment authorisation process. FIG. 3 shows a modified arrangement of the embodiment of FIG. 1 which includes an authorisation instance 5. The authorisation instance 5 receives a request 53 to carry out an authorisation of, for example, a payment transaction. This in turn passes an authentication request 51 to the server 4 to verify the location of the associated mobile device. The server 4 carries out authentication of the mobile device location, as described above, and passes the response 52 to the authentication request 51 back to the authorisation instance 5. Once the authentication response 52 is received, the authorisation instance can then determine whether other authorisation criteria are met and then, assuming the authentication response is positive, issue an appropriate authorisation response 54.

The authentication instance may be generated by a remote server possibly from a completely separate organisation or may be part of the server 4 as a part of a consolidated system.

1.-34. (canceled)

35. A verification method, comprising:
receiving positioning information from a mobile device, the positioning information being derived from Navigation System signals received by the mobile device;
receiving reference information from a base station, the reference information being derived from Navigation System signals received by the base station; and
comparing the positioning information to the reference information, such that the reliability of the positioning information can be verified.

36. The method according to claim 35, wherein the positioning information and reference information comprise:
at least a portion of a Navigation System signal; and
the comparing step comprises:
comparing at least a part of the portion of the Navigation System signal in the positioning information with at least a part of the portion of the Navigation System signal in the reference information to determine if there is a difference within the Navigation System signal as received by the mobile device and as received by the base station.

37. The method according to claim 35, wherein the positioning information and reference information comprise:
the order in which Navigation System signals were received by the mobile device and base station, respectively; and
the comparing step comprises:
comparing the order in which Navigation System signals were received by the mobile device and base station.

38. The method according to claim 35, wherein the positioning information and reference information are related to the time of flight of at least one Navigation System signal, and the comparing step comprises:
comparing the times of flight of equivalent Navigation Signals.

39. The method according to claim 35, further comprising:
determining the expected positioning information for a mobile device located at a given location based on the reference information, wherein the comparing step comprises:
comparing the positioning information to the expected positioning information.

40. The method according to claim 35, further comprising:
storing at least a portion of the positioning information received from the mobile device, wherein the comparing step comprises:
comparing the positioning information to at least part of the portion of the stored positioning information to determine if there is a discontinuity in the positioning information over time.

41. The method according to claim 35, further comprising:
determining the location of the mobile device based on the received positioning information;
receiving location information from the mobile device representing the location of the mobile device as determined by the mobile device; and
comparing the determined location with the location information received from the mobile device.

42. The method according to claim 41, wherein the reference information further comprises:
Navigation System correction information; and
determining the location of the mobile device includes using the correction information.

43. The method according to claim 35, further comprising:
sending a signal to the mobile device indicating which portion of the Navigation System signals received by the device are to be incorporated into the positioning information.

44. A method for use in authenticating a transaction, comprising:
receiving a request from a terminal to authenticate a transaction;
receiving information from the terminal identifying a token that is being used to initiate the transaction;
identifying a mobile device that is associated with the token;
determining the location of the mobile device;
verifying the determined location of the mobile device by verifying the reliability of position information derived from Navigation System signals received by the mobile device;
comparing the location of the mobile device to the location of the transaction; and
authenticating the transaction if the location of the mobile device is within a predetermined area relative to the location of the transaction and the location of the mobile device has been verified.

45. A system for determining the reliability of Navigation System signals received by a mobile device, the system comprising:
a mobile device having a Navigation System receiver and adapted to produce positioning information derived from Navigation System signals;
a base station having a Navigation System receiver and adapted to produce reference information derived from Navigation System signals;
a server having a processor;
a first communication link between the server and mobile device for transmitting positioning information from the mobile device to the server; and
a second communication link between the server and the base station for transmitting reference information to the server;
wherein the processor is programmed to compare the positioning information to the reference information, such that the reliability of the positioning information can be verified.

46. The system according to claim 45, wherein the positioning information and reference information comprise:
at least a portion of a Navigation System signal; and
the processor is adapted to compare at least a part of the portion of the Navigation System signal in the positioning information and at least a part of the portion of the Navigation System signal in the reference information to determine if there is a difference within the Navigation System signal as received by the mobile device and as received by the base station.

47. The system according to claim 45, wherein the positioning information and reference information comprise:
the order in which Navigation System signals were received by the mobile device and base station respectively; and
the processor is adapted to compare the order in which Navigation System signals were received by the mobile device and base station.

48. The system according to claim 45, wherein the positioning information and reference information are related to the time of flight of at least one Navigation System signal, and the processor is adapted to compare the times of flight of equivalent Navigation Signals.

49. The system according to claim 45, wherein the processor is adapted to determine the expected positioning information for a mobile device located at a given location based on the reference information, and the processor is further adapted to compare the positioning information to the expected positioning information.

50. The system according to claim 45, wherein the server further comprises:
memory coupled to the processor for storing at least a portion of the positioning information received from the mobile device, wherein the processor is adapted to compare the positioning information to at least part of the portion of the stored positioning information to determine if there is a discontinuity in the positioning information over time.

51. The system according to claim 45, wherein the processor is adapted to determine the location of the mobile device based on the received positioning information, and the processor is further adapted to compare the determined location of the mobile device with the location of the mobile device as determined by the mobile device.

52. The system according to claim 51, wherein the base station further comprises:
a Navigation System correction system receiver and is adapted to produce correction information derived from Navigation System correction system signals; and
the processor is further adapted to determine the location of the mobile device using the correction information.

53. The system according to claim 45, wherein the server is adapted to send a signal to the mobile device indicating which portion of the Navigation System signals received by the device are to be incorporated into the positioning information.
